(19) United States
(12) Patent Application Publication
(10) Pub. No.: US 2026/0290895 A1
(43) Pub. Date: Sep. 24, 2026

(54) ELECTROLYTE ADDITIVE FOR SECONDARY BATTERIES

(71) Applicant: UChicago Argonne, LLC, Chicago, IL (US)

(72) Inventors: Chi Cheung Su, Chicago, IL (US); Rachid Amine, Bolingbrook, IL (US); Khalil Amine, Oak Brook, IL (US)

(73) Assignee: UChicago Argonne, LLC, Chicago, IL (US)

(21) Appl. No.: 19/079,319

(22) Filed: Mar. 13, 2025

Related U.S. Application Data
(60) Provisional application No. 63/649,197, filed on May 17, 2024.

(51) Int. Cl. H01M 10/0567; H01M 4/02; H01M 4/38; H01M 4/505; H01M 4/525; H01M 4/58; H01M 4/587; H01M 10/0525; H01M 10/054; H01M 10/44

(52) U.S. Cl. CPC H01M 10/0567; H01M 4/386; H01M 4/505; H01M 4/525; H01M 4/5825; H01M 4/587; H01M 10/0525; H01M 10/054; H01M 10/446; H01M 2004/027; H01M 2004/028

(57) ABSTRACT

An electrochemical cell includes a cathode having a pre-lithiation or pre-sodiation agent; an anode; and an electrolyte that includes an oxygen scavenger, and where the electrochemical cell is configured to operate at a voltage greater than 4.2 V.

### CROSS-REFERENCE TO RELATED APPLICATIONS

This application claims priority to and the benefit of U.S. Provisional Application No. 63/649,197, filed on May 17, 2024, which is incorporated herein by reference in its entirety.

### GOVERNMENT RIGHTS

This invention was made with government support under Contract No. DE-AC02-06CH11357 awarded by the United States Department of Energy to UChicago Argonne, LLC, operator of Argonne National Laboratory. The government has certain rights in the invention.

### FIELD

The present technology is generally related to secondary batteries. More particularly, the technology is related to the pre-lithiation or pre-sodiation of cathode materials in the presence of an oxygen scavenger in the electrolyte.

### SUMMARY

In one aspect, an electrochemical cell includes a cathode having a pre-lithiation or pre-sodiation agent; an anode; and an electrolyte that includes an oxygen scavenger. In some embodiments, the cathode is a laminated cathode including a current collector, a cathode active material, and the pre-lithiation or pre-sodiation agent. In some embodiments, the cathode active material comprises a binder and the pre-lithiation agent or pre-sodiation is distributed throughout the cathode active material and the binder. In further embodiments, the pre-lithiation or pre-sodiation agent is present as a coating on the surface of the cathode active material, or it is embedded within the cathode active material. In further embodiments, the oxygen scavenger may be present in the cathode material alone without a pre-lithiation or pre-sodiation agent, particularly where the cell is to be operated at voltages higher than 4.2V. The oxygen scavenger may be present in the electrolyte from about 0.01 wt % to about 8 wt %, while in other embodiments from about 0.01 wt % to about 5 wt %.

In another aspect, a process of preparing an electrochemical cell is provided, where the process includes providing a cathode having a cathode active material and a pre-lithiation or pre-sodiation agent; providing an anode; and providing an electrolyte comprising an oxygen scavenger; and assembling the electrochemical cell with the cathode and anode separated by a porous separator. Such cell may be as-prepared. In such embodiments, the process may also include charging the electrochemical cell at a potential of 4.5V or greater to pre-lithiate or pre-sodiate the cathode active material. In various embodiments, the charging is conducted at a potential of 4.2 to 5 V, or of 4.5 to 5 V.

### BRIEF DESCRIPTION OF THE DRAWINGS

FIGS. 1A and 1B are illustrations of a cathode and anode of the present disclosure, according to various embodiments.

FIGS. 2A and 2B are graphs of cycling (2A) and Coulombic efficiency (2B) of baseline Si∥NMC (no pre-lithiation) and Si∥Li₂O₂—NMC (pre-lithiated at either 0.065 mg/cm² or 0.1 mg/cm² with Li₂O₂) cells using conventional electrolyte (“Gen II,” i.e., 1.2M LiPF6 in 3:7 EC-EMC solution), according to the examples.

FIG. 3 is a relative atomic ratio of silicon anode from Si|NMC and Si∥Li₂O₂—NMC cells after three formation (activation) cycles, according to the examples.

FIGS. 4A and 4B are graphs of cycling (4A) and Coulombic efficiency (4B) of Si∥Li₂O₂—NMC cells using conventional GEN II electrolyte with and without the addition of 1 wt. % tetrahydrothiophene 1-oxide (THTO), according to the examples.

FIG. 5 includes ¹H NMR spectra of THTO, TMS, and the GEN II+1% THTO electrolyte harvested after the activation of Li₂O₂ composite cathode.

FIGS. 6A and 6B are graphs of cycling (6A) and Coulombic efficiency (6B) of Si∥Li₂O₂—NMC cells using conventional GEN II electrolyte with and without the addition of 1 wt. % tris(2,2,2-trifluoroethyl) phosphite (TTFPi), according to the examples.

FIG. 7 includes ¹⁹F NMR spectra of TTFPi and TTFPa and the GEN II+2% TTFPi electrolyte harvested after the activation of Li₂O₂ composite cathode.

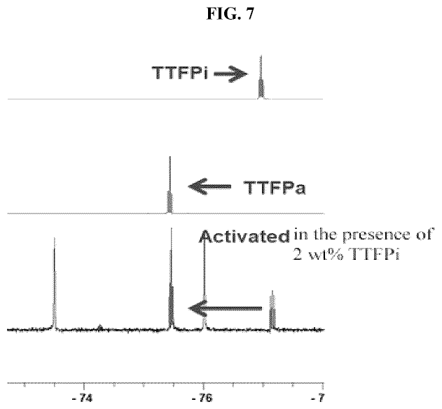

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As utilized herein with respect to numerical ranges, the terms “approximately,” “about,” “substantially,” and similar terms will be understood by persons of ordinary skill in the art and will vary to some extent depending upon the context in which it is used. If there are uses of the terms that are not clear to persons of ordinary skill in the art, given the context in which it is used, the terms will be plus or minus 10% of the disclosed values. When “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, “substituted” refers to a group, as defined below (e.g., an alkyl or aryl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, carbonyls(oxo), carboxyls, esters, urethanes, thiols, sulfides, sulfoxides, sulfones, sulfonyls, sulfonamides, amines, isocyanates, isothiocyanates, cyanates, thiocyanates, nitro groups, nitriles (i.e., CN), and the like.

Alkyl groups include straight chain and branched alkyl groups having from 1 to 20 carbon atoms or, in some embodiments, from 1 to 12, 1 to 8, 1 to 6, or 1 to 4 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tert-butyl, neopentyl, isopentyl, and 2,2-dimethylpropyl groups. Representative substituted alkyl groups may be substituted one or more times with substituents such as those listed above. Where the term haloalkyl is used, the alkyl group is substituted with one or more halogen atoms.

Cycloalkyl groups are cyclic alkyl groups (as are considered to be a subset of alkyl) such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 3 to 6, or 3 to 7. Cycloalkyl groups further include mono-, bicyclic and polycyclic ring systems, such as, for example bridged cycloalkyl groups as described below, and fused rings, such as, but not limited to, decalinyl, and the like. In some embodiments, polycyclic cycloalkyl groups have three rings. Substituted cycloalkyl groups may be substituted one or more times with non-hydrogen and non-carbon groups as defined above. However, substituted cycloalkyl groups also include rings that are substituted with straight or branched chain alkyl groups as defined above. Representative substituted cycloalkyl groups may be mono-substituted or substituted more than once, such as, but not limited to, 2,2-, 2,3-, 2,4- 2,5- or 2,6-disubstituted cyclohexyl groups, which may be substituted with substituents such as those listed above.

Alkenyl groups include straight and branched chain and cycloalkyl groups as defined above, except that at least one double bond exists between two carbon atoms. Thus, alkenyl groups have from 2 to about 20 carbon atoms, and typically from 2 to 12 carbons or, in some embodiments, from 2 to 8, 2 to 6, or 2 to 4 carbon atoms. In some embodiments, alkenyl groups include cycloalkenyl groups having from 4 to 20 carbon atoms, 5 to 20 carbon atoms, 5 to 10 carbon atoms, or even 5, 6, 7, or 8 carbon atoms. Examples include, but are not limited to vinyl, allyl, CH═CH(CH₃), CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl, among others. Representative substituted alkenyl groups may be mono-substituted or substituted more than once, such as, but not limited to, mono-, di- or tri-substituted with substituents such as those listed above

Alkynyl groups include straight and branched chain alkyl groups, except that at least one triple bond exists between two carbon atoms. Thus, alkynyl groups have from 2 to about 20 carbon atoms, and typically from 2 to 12 carbons or, in some embodiments, from 2 to 8, 2 to 6, or 2 to 4 carbon atoms. Examples include, but are not limited to —C≡CH, —C≡C(CH₃), —C≡C(CH₂CH₃), —CH₂C≡CH, —CH₂C≡C(CH₃), and —CH₂C≡C(CH₂CH₃), among others. Representative substituted alkynyl groups may be mono-substituted or substituted more than once, such as, but not limited to, mono-, di- or tri-substituted with substituents such as those listed above.

Aryl, or arene, groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. Although the phrase “aryl groups” includes groups containing fused rings, such as fused aromatic-aliphatic ring systems (e.g., indanyl, tetrahydronaphthyl, and the like), it does not include aryl groups that have other groups, such as alkyl or halo groups, bonded to one of the ring members. Rather, groups such as tolyl are referred to as substituted aryl groups. Representative substituted aryl groups may be mono-substituted or substituted more than once. For example, monosubstituted aryl groups include, but are not limited to, 2-, 3-, 4-, 5-, or 6-substituted phenyl or naphthyl groups, which may be substituted with substituents such as those listed above.

“Alkoxy” refers to the group —O-alkyl wherein alkyl is defined herein. Alkoxy includes, by way of example, methoxy, ethoxy, n-propoxy, isopropoxy, n-butoxy, t-butoxy, sec-butoxy, and n-pentoxy.

The present application is related to solving a problem with high voltage pre-lithiation (or pre-sodiation) of cathode active materials for lithium (or sodium) ion batteries. During pre-lithiation (or pre-sodiation) of a cathode active material, a coating of a lithium-containing oxide (e.g. Li₂O₂, Li₂O, LiO₂, or both, or the sodium counterparts Na₂O₂, Na₂O, NaO₂) is deposited on the surface of the cathode active material or imbanded in the cathode. Upon activation of the cathode active material with the pre-lithiation (or sodiation) reagent, i.e. conditioning of the cathode active material at greater than 4.2 V, lithium is disproportionated from the lithium-containing oxide, concomitantly producing oxygen. In other words, upon oxidation, pre-lithiation agents, such as Li₂O are oxidized to lithium peroxide with the release of lithium cations (Li⁺). Lithium peroxide may then be further oxidized to superoxide with the release of Li⁺. When further oxidized, the lithium superoxide releases Li+ and dioxygen. The activation process of Li₂O may be depicted by Scheme 1, below. Note that sodium may replace the lithium in these schemes and illustrative embodiments.

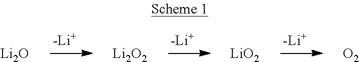

While the pre-lithiation produces batteries of higher quality and durability, the oxygen species generation can be detrimental to the cell. For example, the oxygen species generated (e.g. the lithium superoxide or oxide) can then react with the electrolyte solvents and/or salts, or they may diffuse into the anode and deleteriously react with the lithiated anode. Ultimately, this results in a reduction in the available Li⁺, and overall cell degradation. It is to be noted that where “pre-lithiation” is described herein, the devices and processes or methods may also be used for “pre-sodiation,” where the lithium species such as Li₂O, Li₂O₂ LiO₂ and the like are exchanged for the corresponding sodium materials (i.e. Na₂O, Na₂O₂, NaO₂ and the like).

It has now been found that oxygen scavengers may be added to the electrolyte, such that the oxygen generated during pre-lithiation may be scavenged in situ to avoid the detrimental effects otherwise associated with the lithiation. As set forth herein, the description and examples will illustrate that when pre-lithiation of a cathode active material is conducted at high voltage in the presence of oxygen scavengers, a significant improvement of full-cell capacity is observed, as well as providing higher safety measures to prevent pressure build-up often associated with the oxygen generation. The technology described herein can be used to scavenge the O₂ released at high voltage for all cathodes, such as layered oxide cathodes.

In a first aspect, provided is an electrochemical cell containing a cathode active material including a pre-lithiation agent, an anode comprising a porous material, and an electrolyte comprising a salt, an aprotic solvent, and an oxygen scavenger. In any of these embodiments, the pre-lithiation agent may include Li₂O, Li₂O₂, LiO₂, or a mixture thereof. In some embodiments, the pre-lithiation agent may be Li₂O, Li₂O₂, LiO₂ or a mixture thereof. In any such embodiments, the oxygen scavenger may be a compound that under an applied voltage of greater than 4.2V reacts spontaneous with either superoxide or oxygen in solution to form an otherwise inert material. In some embodiments, the applied voltage is greater than 4.5 V. Similarly, a sodium electrochemical cell may be provided that a cathode active material including a pre-sodiation agent, an anode comprising a porous material, and an electrolyte comprising a salt, an aprotic solvent, and an oxygen scavenger. In any of these embodiments, the pre-sodiation agent may include Na₂O, Na₂O₂, NaO₂, or a mixture thereof. In some embodiments, the pre-sodiation agent may be Na₂O, Na₂O₂, NaO₂ or a mixture thereof. In various embodiments, the oxygen scavenger may be an alkyl sulfoxide, and alkyl sulfite, an alkyl phosphane, an alkyl phosphonite, an alkyl phosphite, or a mixture of any two or more thereof.

As noted above, the pre-lithiation of the electrochemical cell includes the degradation of the pre-lithiation agent into its constituent elements. Because of this, in some embodiments, the electrochemical cells or cathodes are described as “as-prepared.” As used herein, “as-prepared” refers to a cell, cathode, or battery, as prepared, prior to any charging of the cell, cathode, or battery, or discharging of the cell, cathode, or battery. The “as-prepared” does not imply any sort of time constraint, or in other words, the cell, cathode, or battery may actually have been prepared long ago, but it was not subjected to any charging or discharging process. Accordingly, the as-prepared cathode or battery has not been subjected to electrochemical processes that would generate any lithium species other those species that were included in the battery or cathode in the first instance. In some embodiments, electrochemical cell may be a secondary battery, and the as-prepared secondary battery may be a non-discharged secondary battery. In other embodiments, the cathode is a non-discharged cathode.

In some embodiments, the oxygen scavenger is an alkyl sulfoxide that may be represented by any of the following formulae:

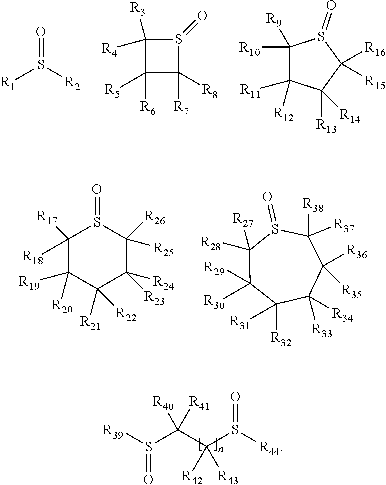

In the above formulae, each of R₁-R₄₄ is independently H, NO, F, Cl, Br, I, alkyl, alkoxy, fluoroalkyl, fluoroaryl, haloalkyl, heteroalkyl, aryl, alkenyl, alkynyl, N(R), —OP(R), OP(OR), C(O)R, C(O)OR, S(O)OR, or S(O)R where R is alkyl group; and n may be 0, 1, 2, 3 or 4. Illustrative alkyl sulfoxides include, but are not limited to, dimethyl sulfoxide, bis(trifluoroethyl) sulfoxide, tetrahydrothiophene 1-oxide, and derivatives thereof.

In some embodiments, the oxygen scavenger may be an alkyl sulfite represented by one of the following formulae:

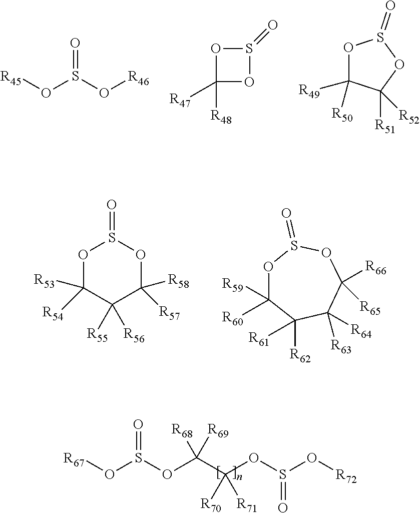

In the above formulae, each of R₄₅-R₇₂ is independently H, NO, F, Cl, Br, I, alkyl, alkoxy, fluoroalkyl, fluoroaryl, haloalkyl, heteroalkyl, aryl, alkenyl, alkynyl, N(R), —OP(R), OP(OR), C(O)R, C(O)OR, S(O)OR, or S(O)R where R is alkyl group; and n may be 0, 1, 2, 3 or 4. Illustrative alkyl sulfites include, but are not limited to, ethylene sulfite, dimethyl sulfite, and derivatives thereof.

In some embodiments the alkyl phosphane may be a compound represented by one or more of the following formulae:

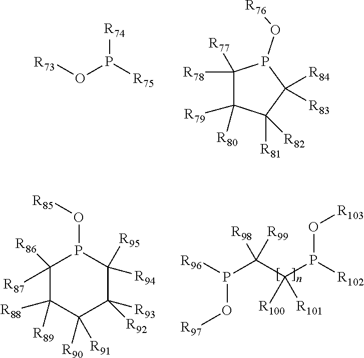

In the above formulae, each of R₇₃-R₁₀₃ is independently H, NO, F, Cl, Br, I, alkyl, alkoxy, fluoroalkyl, fluoroaryl, haloalkyl, heteroalkyl, aryl, alkenyl, alkynyl, N(R), —OP(R), OP(OR), C(O)R, C(O)OR, S(O)OR, or S(O)R where R is alkyl group, and n may be 0, 1, 2, 3 or 4. Illustrative alkyl phosphanes include, but are not limited to, methoxydimethylphosphane, methoxybis(2,2,2-trifluoroethyl)phosphane, 1-methoxyphospholane, and derivatives thereof.

In some embodiments the oxygen scavenger may be an alkyl phosphonite represented by one or more of the following formulae:

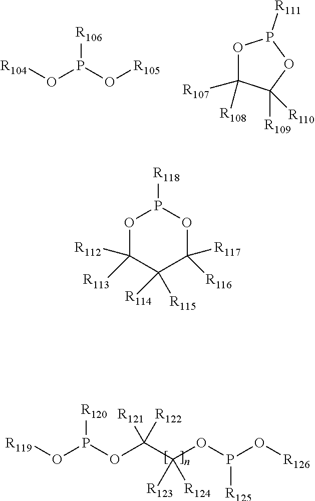

In these formulae, each of R₁₀₄-R₁₂₆ is independently H, NO, F, Cl, Br, I, alkyl, alkoxy, fluoroalkyl, fluoroaryl, haloalkyl, heteroalkyl, aryl, alkenyl, alkynyl, N(R), —OP(R), OP(OR), C(O)R, C(O)OR, S(O)OR, or S(O)R where R is alkyl group; and n may be 0, 1, 2, 3 or 4. Illustrative alkyl phosphonites include, but are not limited to, diethyl methylphosphonite, dimethyl phenylphosphonite, and derivatives thereof.

In some embodiments, the oxygen scavenger may include an alkyl phosphite represented by one of the following formulae:

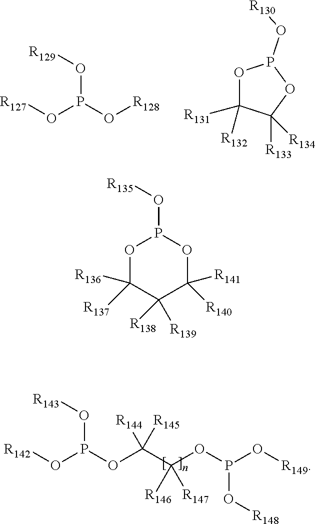

In these formulae, each of R₁₂₇-R₁₄₉ is independently H, NO, F, Cl, Br, I, alkyl, alkoxy, fluoroalkyl, fluoroaryl, haloalkyl, heteroalkyl, aryl, alkenyl, alkynyl, N(R), —OP(R), OP(OR), C(O)R, C(O)OR, S(O)OR, or S(O)R where R is alkyl group, and n may be 0, 1, 2, 3 or 4. Illustrative alkyl phosphites include, but are not limited to, trimethyl phosphite, 2-methoxy-1,3,2-dioxaphospholane, tris(2,2,2-trifluoroethyl) phosphite, and derivatives thereof.

In the above embodiments, fluoroalkyl/haloalkyl groups may include straight chain and branched fluoroalkyl groups having from 1 to 8 carbon atoms and containing at least one fluorine atom. Examples of fluoroalkyl groups include those with from 1 to 8 carbon atoms and at least 1 fluorine atom such as —CFH₂, —CF₂H, —CF₃, —CH₂CH₃, —CFHCH₃, —CH₂CFH₂, —CH₂CF₂H, —CH₂CF₃, —CFHCH₃, —CFHCFH₂, —CFHCF₂H, —CFHCF₃, —CF₂CH₃, —CF₂CFH₂, —CF₂CF₂H, —CF₂CF₃, —CHCH₂, —CFCH₂, —CHCFH, —CHCF₂, —CFCFH, —CFCF₂, —CH₂CF₂CF₃, —CF(CH₃)₂, —CH₂CF₂CF₃, —CF₂CF(CF₃)₂, —CH₂CF₂CF₂H, —CH₂OCF₃, —CF₂OCF₃, —CH₂OCF₂CF₂CF₃, —CH₂OCF₂CF₂CF₂CF₃, and —CF₂OCF₂CF₂CF₃.

In the above embodiments, fluoroaryl groups may include cyclic aromatic hydrocarbons that contain at least 1 fluorine atom. Fluoroaryl groups include monocyclic, bicyclic and polycyclic ring systems. Thus, fluoroaryl groups include, but are not limited to, fluorophenyl, fluoroazulenyl, fluoroheptalenyl, fluoroindacenyl, fluorofluorenyl, fluorophenanthrenyl, fluorotriphenylenyl, fluoropyrenyl, fluoronaphthacenyl, fluorochrysenyl, fluorobiphenyl, fluoroanthracenyl, fluoroindenyl, fluoroindanyl, fluoropentalenyl, and fluoronaphthyl groups. In some embodiments, fluoroaryl groups contain 6-14 carbons, and in others from 6 to 12 or even 6-10 carbon atoms in the ring portions of the groups with at least 1 fluorine atom.

According to various specific embodiments, suitable oxygen scavengers may include, tetrahydrothiophene 1-oxide, dimethyl sulfoxide, fluorinated alkyl sulfoxide, ethylene sulfite, fluoroethylene sulfite, alkyl phosphinite, fluorinated alkyl phosphinite, alkyl phosphonite, fluorinated alkyl phosphonite, trimethylphosphite, tris(2,2,2-trifluoroethyl) phosphite, trialkyl phosphite, fluorinated trialkyl phosphite, lithium chlorate, or a combination of any two or more thereof. According to various specific embodiments, suitable oxygen scavengers as alkyl sulfoxide and fluorinated alkyl sulfoxides include, but are not limited to, tetrahydrothiophene 1-oxide, dimethyl sulfoxide, tetrahydro-2H-thiopyran 1-oxide, thietane 1-oxide and its derivatives. 3-(trifluoromethyl)tetrahydrothiophene 1-oxide, 1,1,1-trifluoro-2-((2,2,2-trifluoroethyl)sulfinyl)ethane, 1,1,1-trifluoro-2-(methylsulfinyl)ethane and its derivatives. According to various specific embodiments, suitable oxygen scavengers as alkyl phosphinite additives include, but are not limited to, methyl diphenylphosphinite, methoxydimethylphosphine, dimethyl(2,2,2-trifluoroethoxy)phosphine, 1-methoxyphospholane, and its derivatives.

In other embodiments, the oxygen scavenger may be a cathode active material itself that is added at low amounts. Such cathode active materials can include high lithium and high manganese content materials. The oxygen scavenger may be a cathode active material that contains a prelithiation or presodiation material. In some embodiments, particularly when operating an electrochemical cell at voltages greater than 4.2V, a lithium-based cathode or a sodium-based cathode can generate oxygen and therefore an oxygen scavenger may be effective in eliminating the negative effect of released oxygen on the performance of the cell.

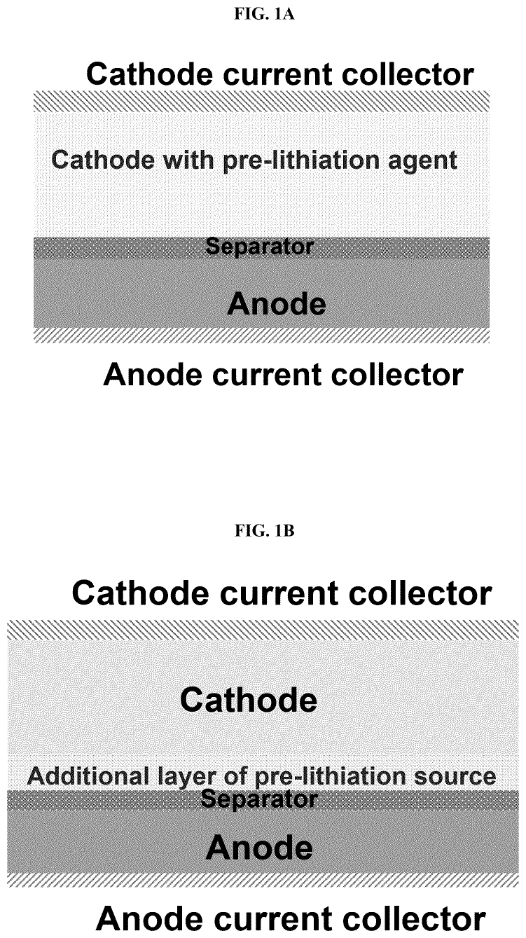

As noted above, the cathode active material includes a pre-lithiation (or pre-sodiation) agent. In some embodiments, the pre-lithiation agent may be blended with the cathode active material and applied to a current collector. Such a configuration is illustrated in FIG. 1A, where a cathode with pre-lithiation agent is applied to a cathode current collector. In other embodiments, the cathode active material is first formed into a cathode with a cathode current collector, and then the cathode active material is coated with a pre-lithiation agent. Such a configuration is illustrated in FIG. 1B, where the cathode and pre-lithiation agent are in layers on the cathode current collector. Thus, the cathode active material may include a pre-lithiation agent that includes Li₂O₂, Li₂O, or a mixture thereof.

The pre-lithiation reagent may also include Li-rich/Mn-rich materials such as those of formula: δLi₂M⁷O₃·(1-δ)LiM⁸O₂, where M⁷ is one or more trivalent ions with at least one ion being Mn³⁺ or Ni³⁺, and where M⁸ is one or more tetravalent ions, with 1>δ>0. (where the overall weight ratio of lithium should be 30% or less). Such materials require activation at high voltage (>4.5V vs. Li/Li⁺), with the release of reactive oxygen species. After the activation process, these materials can also remain redox active during subsequent cycling. When present as a coating on the surface of the cathode active material, and the ratio of pre-lithiation or pre-sodiation agent to the cathode active material is from greater than 0 wt % to less than 15 wt %, or from greater than 1 wt % to less than 10 wt %, or greater than 1 wt % to less than 8 wt %.

As noted above, the compositions and methods described herein may be used for scavenging 02 released at high voltage for all cathodes (layered oxides) that release oxygen. The cathode active materials may be any commonly used cathode active materials for lithium ion batteries, where the cathode active material is amenable to pre-lithiation at high voltage (i.e. about 4.5V or above). Illustrative cathode active materials may include material such as lithium nickel manganese cobalt oxides (LiNiMnCo) materials, as well as LiCoO₂ (LCO), LiFePO₄, LiMn₂O₄ (LMO), LiMeO₂, or Li_{1+x″}Ni_{α}Mn_{β}Co_{γ}M_{δ′}O₂, wherein Me may be Ni, Mn, or Co; M may be Mg, Zn, Al, Ga, B, Zr, or Ti; 0≤x″≤0.4; 0≤α≤1; 0≤β≤1; 0≤δ′≤1; and 0≤γ≤1; with the proviso that at least one of α, β and γ is greater than 0. In some embodiments, illustrative cathode active materials include, but are not limited to, LiCoO₂ (LCO), LiFePO₄, LiMn₂O₄ (LMO), LiNi_{1/3}Mn_{1/3}Co_{1/3}O₂ (NMC), LiNi_{0.8}Co_{0.15}Al_{0.05}O₂ (NCA), LiNi_{0.5}Mn_{1.5}O₄ (LNMO), Li_{1.2}Ni_{0.15}Co_{0.10}Mn_{0.55}O₂ (0.49Li₂MnO₃·0.51LiNi_{0.37}Co_{0.24}Mn_{0.39}O₂), LiFe_{0.4}Mn_{0.6}PO₄, or LiFe_{0.3}Mn_{0.7}PO₄. In some embodiments, the cathode active material is an NMC material.

In other embodiments, the cathodic active material may include either lithiated materials or surface coated lithiated materials. For example, such materials and composites include, but are not limited to, MnO₂, V₂O₅, LiVO₃, air (oxygen), FeF₂, a spinel, an olivine, a carbon-coated olivine, LiFePO₄, LiCoO₂, LiNiO₂, LiNi₁₋ₓCo_{y}M⁴_{z}O₂, LiMn_{0.5}Ni_{0.5}O₂, Li₁₊ₓMn_{2-z}M⁴_{y}O₄₋ₘX¹ₙ, LiFe_{1-z}M⁶_{y}PO₄₋ₘX¹ₙ, LiMn_{1/3}Co_{1/3}Ni_{1/3}O₂, LiM n₂O₄, LiFeO₂, LiM⁴_{0.5}Mn_{1.5}O₄, Li_{1+x″}Ni_{α}Mn_{β}Co_{γ}M⁵_{δ}O_{2-z″} both single composition or gradient composition, Li₂MnO₃—LiₐM_{b}M′_{c}M″_{d}Oₑ, Liₙ·B¹₂(M²O₄)₃ (Nasicon), Li₂MSiO₄, or a mixture of any two or more thereof, wherein M² is P, S, Si, W, or Mo; M⁴ is Al, Mg, Ti, B, Ga, Si, Ni, or Co; M⁵ is Mg, Zn, Al, Ga, B, Zr, or Ti; A is Li, Ag, Cu, Na, Mn, Fe, Co, Ni, or Zn; M⁶ is Al, Mg, Ti, B, Ga, Si, Ni, Mn or Co; M, M′, and M″ are transition metals; B¹ is Ti, V, Cr, Fe, or Zr; X¹ is S or F; 0≤x≤0.3; 0≤y≤0.5; 0≤z≤0.5; 0≤m≤0.5; 0≤n≤0.5; 0≤x″≤0.4; 0≤a≤2; 0≤b≤1; 0≤c≤1; 0≤d≤1; 0≤α≤1; 0≤β≤1; 0≤γ≤1; 0≤δ≤0.4; 0≤z″≤0.4; 0≤n′≤3; 0≤a+b+c+d<6; 0<e≤4; and 0≤α+β+γ+δ.

For sodium secondary batteries, or cathodes to be used in sodiated secondary batteries, the cathode active material may include either sodiated materials or surface coated sodiated materials. For example, such materials and composites include, but are not limited to a spinel, an olivine, a carbon-coated olivine, NaFePO₄, NaCoO₂, NaNiO₂, NaNi₁₋ₓCo_{y}M⁴_{z}O₂, NaMn_{0.5}Ni_{0.5}O₂, NaMn_{1/3}Co_{1/3}Ni_{1/3}O₂, NaMn₂O₄, NaFeO₂, NaM⁴_{0.5}Mn_{1.5}O₄, Na_{1+x″}Ni_{α}Mn_{β}Co_{γ}M⁵_{δ}O_{2-z″}F_{z″}, Na₂MnO₃—NaₐM_{b}M′_{c}M″_{d}Oₑ, Naₙ·B¹₂(M²O₄)₃ (Nasicon), Na₂MSiO₄, Na₁₋ᵥM⁵O₂, NaVPO₄F or a mixture of any two or more thereof, wherein M² is P, S, Si, W, or Mo; M⁴ is Al, Mg, Ti, B, Ga, Si, Mn, or Co; M⁵ is Mg, Zn, Al, Ga, B, Zr, or Ti; M⁵ is a trivalent metal ion that includes Mn³⁺ and/or Fe³⁺; M, M′, and M″ are transition metals; B¹ is Ti, V, Cr, Fe, or Zr; 0≤v≤0.56; 0≤x≤0.3; 0≤y≤0.5; 0≤z≤0.5; 0≤m≤0.5; 0≤n≤0.5; 0≤x″≤0.4; 0≤a≤2; 0≤b≤1; 0≤c≤1; 0≤d≤1; 0≤δ≤1; 0≤β≤1; 0≤γ≤1; 0≤δ≤1; 0≤δ′≤0.4; 0≤z″≤0.4; 0≤n′≤3; 0≤a+b+c+d, and 0<e.

The cathode active material may include, in some embodiments, a spinel, an olivine, or a carbon-coated olivine. For example, the cathode active material may be, according to an embodiment, a spinel manganese oxide of formula of Li₁₊ₓMn_{2-z}M⁴_{y}O₄₋ₘX¹ₙ, wherein M⁴ is Al, Mg, Ti, B, Ga, Si, Ni, or Co; X¹ is S or F; 0≤x≤0.3; 0≤y≤0.5; 0≤z≤0.5; 0≤m≤0.5; and 0≤n≤0.5. The cathode active material may be, according to an embodiment, an olivine of formula of LiFe_{1-z}M⁶_{y}PO₄₋ₘX¹ₙ or a mixture of any two or more such olivines; wherein M⁶ is Al, Mg, Ti, B, Ga, Si, Ni, Mn or Co; X¹ is S or F; 0≤x≤0.3; 0≤y≤0.5; 0≤z≤0.5; 0≤m≤0.5; and 0≤n≤0.5.

The cathode active material may include a blend of a spinel and Li_{1+x″}Ni_{α}Mn_{β}Co_{γ}M⁵_{δ}O_{2-z″}F_{z}, wherein M⁵ is Mg, Zn, Al, Ga, B, Zr, or Ti; 0≤x″≤0.4; 0≤α≤1; 0≤β≤1; 0≤γ≤1; 0≤δ≤0.4; 0≤z″≤0.4; 0≤α+β+γ+δ. The ratio of the spinel to the Li_{1+x″}Ni_{α}Mn_{β}Co_{γ}M⁵_{δ}O_{2-z″}F_{z} may be from about 0.5 wt % to about 98 wt %. Alternatively, the cathode may include a blend of an olivine or a carbon-coated olivine, and Li_{1+x″}Ni_{α}Mn_{β}Co_{γ}M⁵_{δ}O_{2-z″}F_{z″} wherein M⁵ is Mg, Zn, Al, Ga, B, Zr, or Ti; 0≤x″≤0.4; 0≤α≤1; 0≤β≤1; 0≤γ≤1; 0≤δ≤0.4; 0≤z″≤0.4; 0≤α+β+γ+δ. The ratio of the ratio of the olivine or carbon-coated olivine to the Li_{1+x″}Ni_{α}Mn_{β}Co_{γ}M⁵_{δ}O_{2-z″}F_{z} may be from about 0.5 wt % to about 98 wt %.

The cathode active material may include a non-lithiated or non-sodiated material such as MnO₂, V₂O₅, LiVO₃, MoS₂, FeS₂, S, organic cathode, air or oxygen cathode such as carbon, FeF₃, FeF₂, or a mixture of any two or more thereof. In other embodiments, the cathode active material includes sulfur. In some embodiments, the cathode active material is air (oxygen).

Where the cathode is for use in a sodium ion electrochemical cell, the cathode active material may include NaM₁₋ₓM′ₓPO₄, NaₓM_{y}M′_{z}O₂, Na₂FePO₄F, Na₂MnPO₄F, NaFeSO₄F, NaMnSO₄F, NaV_{1-α}Cr_{α}PO₄F, Na₂S, Na₂Se, Na₃M⁶₂(PO₄)₃; Na₂M⁶P₂O₇; Na₄M⁶₃(PO₄)₂(P₂O₇); NaₓM⁶_{y}(PO₄)_{z}F; NaₓM⁶_{y}(SO₄)_{z}; Na₂M⁶SiO₄, or a mixture of any two or more thereof, wherein 0<x; 0<y+z; M is Mn, Ni, Fe, Co, or Cu; M′ is Cr or Mg; M⁶ is a tetravalent ion (e.g. V, Sn, Ti, or Fe); and 0≤α≤1 In some embodiments, the cathode active material may include NaₙMnO₂, NaₙNiO₂, NaₙCoO₂, NaₙFeO₂, NaₙCrO₂, NaₙCuO₂, NaₙNiₓFe_{y}Mn_{z}MₐO₂, Naₙ[FeₓMn_{y}Mₐ]O₂, NaFePO₄, Na₂FeP₂O₇, Na₄Fe₃(PO₄)₂P₂O₇, NaₓFe_{0.5}Mn_{0.5}PO₄, Na₃V₂(PO₄)₃, Na₃V₂(PO₄)₂F₃, Na₃(VO_{0.8})₂(PO₄)₂F, Na₂Mn P₂O₇, Na₄Co₃(PO₄)₂P₂O₇, Na₂CoPO₄F, Na₂FePO₄F, or NaFeSO₄F, Prussian Hue, Prussian white, Na₂C₆O₆, or any combination thereof, wherein 0≤n≤1, x+y+z+a=1, x+y+a=1, M is Li, Cu, Zn, Si, Mg, Al, Ca, Cr, Nb, Zr, Sb, and the like.

The cathode may be further stabilized by surface coating the active particles with a material that can neutralize acid or otherwise lessen or prevent leaching of the transition metal ions. Hence the cathodes can also comprise a surface coating of a metal oxide or fluoride such as ZrO₂, TiO₂, ZnO₂, WO₃, Al₂O₃, MgO, SiO₂, SnO₂, AlPO₄, Al(OH)₃, AIF₃, ZnF₂, MgF₂, TiF₄, ZrF₄, LiMPO₄, or LiMBO₃, where in M indicates transition metal such as but not limited to Ni, Mn, Co, or a mixture of any two or more thereof, or of any other suitable metal oxide or fluoride. The coating can be applied to a carbon-coated cathode. The cathode may be further stabilized by surface coating the active particles with polymer materials. Examples of polymer coating materials include, but not limited to, polysiloxanes, polyethylene glycol, or poly(3,4-ethylenedioxythio-phene) polystyrene sulfonate, a mixture of any two or more polymers. The cathode may be carbon-coated to improve the stability and conductivity via chemical or physical method. Examples of carbon coating includes but not limit to high-energy mixing, vapor phase deposition, plasma-assisted chemical vapor deposition (CVD), spraying, liquid-phase deposition, electrochemical deposition, plasma enhanced atomic layer deposition, calcination of carbon precursor, or other mechanical or chemical means.

The cathodes, or the cathode(s) of the secondary battery, also include a primary cathode active material. In some embodiments, the cathode includes a mixture of the electrochemical active material and the primary cathode active material. The primary cathode active material may include a lithiated positive active material, a non-lithiated positive active material, a sodiated positive active material, a non-sodiated positive active material, or a mixture of any two or more thereof. In some embodiments, the primary cathode active material may include a lithiated positive active material, a sodiated positive active material, or a mixture of lithiated and sodiated positive active material.

The primary cathode active material may include a positive active material that is configured to only insert, or de-insert lithium or sodium. For example, the positive active material may be configured to only insert, or de-insert lithium from about 1.5 V to about 5.0 V vs. lithium. Alternatively, the positive active material may be configured to only insert, or de-insert sodium from 1.2 to 5.0 V vs. sodium. As used herein, “insert” or “de-insert” is used to refer to the movement of either the lithium or sodium ion(s) into, or out of, respectively, the cathode material either through absorption, adsorption, intercalation, conversion, or alloying.

The cathode may include a current collector, a porous carbon (e.g. conductive) material, and/or a polymeric binder. Illustrative cathode current collectors include, but are not limited to, copper, stainless steel, titanium, tantalum, platinum, gold, aluminum, nickel, cobalt nickel alloy, highly alloyed ferritic stainless steel containing molybdenum and chromium; or nickel-, chromium-, or molybdenum-containing alloys. The current collector may be a foil, mesh, or screen. The cathodes may also include a conductive carbon material.

The electrochemical cells also include an anode. In some embodiments, the anode includes graphite, Li metal, Cu, Sb, Si, Si—C, SiO, Sn, tin oxide, Li₄Ti₅O₁₂, a composite tin alloy, intermetallic compound, a transition metal oxide, hard carbon, soft carbon or a lithium metal nitride, phosphorus including black and red phosphorus, doped phosphorus, and phosphorus carbon composites; as well as doped phosphorus carbon with Cu, Sb, Si, Si—C, SiO, Sn, tin oxide, Li₄Ti₅O₁₂, a composite tin alloy, a transition metal oxide, or a lithium metal nitride or a mixture of any two or more. In other embodiments, illustrative anode materials include, but are not limited to, a lithium foil, lithium mesh, lithium nanoparticles, conductive carbon, silicon, or a mixture of any two or more. In some embodiments, the anode includes silicon. In another embodiment, an anode free cell that have only copper current collector can be used.

The anodes may also include a current collector, a porous carbon (e.g. conductive) material, and/or a polymeric binder. Illustrative current collectors include, but are not limited to, copper, stainless steel, titanium, tantalum, platinum, gold, aluminum, nickel, cobalt nickel alloy, highly alloyed ferritic stainless steel containing molybdenum and chromium; or nickel-, chromium-, or molybdenum-containing alloys. The current collector may be a foil, mesh, or screen. In some embodiments, the electroactive material disclosed herein and one or more of a conductive carbon material and a binder are contacted with the current collector by casting, pressing, or rolling the mixture thereto. In some embodiments, the current collector is copper, stainless steel, titanium, tantalum, platinum, gold, aluminum, nickel, cobalt, cobalt nickel alloy, highly alloyed ferritic stainless steel containing molybdenum and chromium, a nickel-containing alloy, a chromium-containing alloy, or a molybdenum-containing alloy.

A binder may also be present in the cathodes and/or anodes to retain the active material on the current collector. The binder may be present in the anode in an amount of from about 0.1 wt % to about 30 wt %. In some embodiments, the binder is present in the cathode and/or anode in an amount of from about 5 wt % to about 20 wt %. Illustrative binders include, but are not limited to, polyvinylidene difluoride (PVDF), polyvinyl alcohol (PVA), polyethylene, polystyrene, polyethylene oxide, polytetrafluoroethylene (Teflon), polyacrylonitrile, polyimide, styrene butadiene rubber (SBR), carboxy methyl cellulose (CMC), gelatine, sodium alginate, polythiophene, polyacetylene, poly(9,9-dioctylfluorene-co-fluorenone), poly(9,9-dioctylfluorene-co-fluorenone-co-methylbenzoic ester), a copolymer of any two or more such polymers, and a blend of any two or more such polymers.

Illustrative conductive carbon materials that may be used in the cathodes and anodes include, but are not limited to, synthetic graphite, natural graphite, expanded graphite, graphene, reduced graphene oxide, a metal-organic framework, amorphous carbon, hard carbon, soft carbon, carbon black, acetylene black, carbon spheres, mesocarbon microbeads (MCMB), mesoporous carbon, porous carbon matrix, carbon nanofiber, carbon aerogel, single-walled carbon nanotube, multi-walled carbon nanotubes, carbon nanotube arrays, or a mixture of any two or more thereof. Commercial examples of carbon black include, but are not limited to, TIMCAL Super C45®, Super-P®, Black Pearls® 2000, Denka Black®, Vulcan® XC72R, and Ketjenblack®.

In some embodiments, the electrochemical cells may include a separator between the anode and cathode. Such separators tend to be made of a microporous or modified glass fiber or polymer separator. Illustrative separators include, but are not limited to, Celgard® 2325, Celgard® 2400, Celgard® 3501, and a glass fiber separator.

As noted above, the electrolyte of the electrochemical cell may include the oxygen scavenger, an aprotic solvent, and a salt. Aprotic solvents lack exchangeable protons and include cyclic carbonic acid esters, linear carbonic acid esters, phosphoric acid esters, oligoether substituted siloxanes/silanes, cyclic ethers, chain ethers, lactone compounds, chain esters, nitrile compounds, amide compounds, sulfone compounds and the like. These solvents may be used singly, or at least two of them in admixture. Illustrative aprotic solvents or carriers for forming the electrolyte systems include but are not limited to ethylene carbonate, dimethylcarbonate, diethylcarbonate, propylene carbonate, fluoroethylene carbonate (FEC), ethyl methyl carbonate, dioloxane, γ-butyrolactone, 6-butyrolactone, dimethyl ether, a silane, siloxane N-methyl acetamide, acetonitrile, an acetal, a ketal, esters, a carbonates, a sulfone, a sulfite, sulfolane, an aliphatic ether, a cyclic ether, a glyme, a polyether, a phosphate ester, a siloxane, a n-alkylpyrrolidone, fluoro ether and fluoro esters, fluoroethylene carbonate, or adiponitrile. In some embodiments, the solvent comprises trifluoroethyl methyl carbonate (FEMC), dimethoxyethane (DME), dimethyl carbonate (DMC), 1,3-dioxolane (DOL), ethyl methyl carbonate (EMC), diethyl carbonate (DEC), dimethyl sulfoxide (DMSO), ethyl vinyl sulfone (EVS), tetramethylene sulfone (TMS), ethyl methyl sulfone (EMS), ethylene carbonate (EC), vinylene carbonate (VC), fluoroethylene carbonate (FEC), difluoroethylene carbonate (DFEC), 4-vinyl-1,3-dioxolan-2-one (VEC), dimethyl sulfone, ethyl methyl sulfone, methyl butyrate, ethyl propionate, trimethyl phosphate, triethyl phosphate, gamma-butyrolactone, 4-methylene-1,3-dioxolan-2-one, methylene ethylene carbonate (MEC), 4,5-dimethylene-1,3-dioxolan-2-one, allyl ether, triallyl amine, triallyl cyanurate, triallylisocyanurate, water, or any combination thereof. Of course, a mixture of any two or more such solvents may also be used. In some embodiments, the solvent is a mixture of solvents such as, but not limited to, FEC-DEC, FEC-EC-DEC, FEC-EMC, FEC-EC-EMC, EC-DMC, EC-DEC, EC-PC, EC-PC-DMC, EC-PC-DEC, or EC-DEC-DMC.

Illustrative salts for use in the electrolyte include lithium salts such as, but not limited to, Li[CF₃CO₂]; Li[C₂F₅CO₂]; Li[ClO₄]; Li[BF₄]; Li[AsF₆]; Li[PF₆]; Li[PF₂(C₂O₄)₂]; Li[PF₄C₂O₄]; Li[CF₃SO₃]; Li[N(CF₃SO₂)₂]; Li[C(CF₃SO₂)₃]; Li[N(SO₂C₂F₅)₂]; lithium alkyl fluorophosphates; Li[B(C₂O₄)₂]; Li[BF₂C₂O₄]; Li₂[B₁₂Z₁₂₋ⱼHⱼ]; Li₂[B₁₀X_{10-j′}H_{j′}]; lithium 4,5-dicyano-2-(trifluoromethyl)imidazole; lithium 4,5-dicyano-2-methylimidazole; trilithium 2,2′,2″-tris(trifluoromethyl)benzotris(imidazolate); LiN(CN)₂; lithium 4,5-dicyano-2-(trifluoromethyl)imidazole; lithium 4,5-dicyano-2-methylimidazole; trilithium 2,2′,2″-tris(trifluoromethyl)benzotris(imidazolate); Na[CF₃CO₂]; Na[C₂F₅CO₂]; Na[ClO₄]; Na[BF₄]; Na[AsF₆]; Na[PF₆]; Na[PF₂(C₂O₄)₂]; Na[PF₄C₂O₄]; Na[CF₃SO₃]; Na[N(CF₃SO₂)₂]; Na[C(CF₃SO₂)₃]; Na[N(SO₂C₂F₅)₂]; sodium alkyl fluorophosphates; Na[B(C₂O₄)₂]; Na[BF₂C₂O₄]; Na₂[B₁₂Z₁₂₋ⱼHⱼ]; Na₂[B₁₀X_{10-j′}H_{j′}]; or a mixture of any two or more thereof, wherein Z is independently at each occurrence a halogen, j is an integer from 0 to 12 and j′ is an integer from 1 to 10.

In any or all of the above embodiments, (i) the active salt may have a molar concentration in the electrolyte within a range of from 0.5 M to 2 M (for localized concentrated electrolyte with fluorinated ether diluents); (ii) the active salt may have a molar concentration in the solvent of greater than 3 moles (for concentrated electrolytes) of active salt per liter of the solvent; or (iii) both (i) and (ii). In some embodiments, the molar concentration of the active salt in the electrolyte is at least 20% less than a molar concentration of the active salt in the solvent in the absence of the diluent. In any or all of the above embodiments, (i) a molar ratio of the active salt to the solvent may be within a range of from 0.33 to 1.5; (ii) a molar ratio of the solvent to the diluent may be within a range of from 0.2 to 5; or (iii) both (i) and (ii). In any or all of the above embodiments, at least 90% of molecules of the solvent may be associated with cations of the active salt. In any or all of the above embodiments, fewer than 10% of molecules of the diluent may be associated with cations of the active salt. In any or all of the above embodiments, the active salt may include a lithium salt or lithium salts mixture, a sodium salt or sodium salts mixture, or a magnesium salt or magnesium salts mixture. In some embodiments, the active salt comprises lithium bis(fluorosulfonyl)imide (LiFSI), lithium bis(trifluoromethylsulfonyl)imide (LiTFSI), sodium bis(fluorosulfonyl)imide (NaFSI), sodium bis(trifluoromethylsulfonyl)imide (NaTFSI), lithium bis(oxalato)borate (LiBOB), sodium bis(oxalato)borate (NaBOB), LiPFe, LiAsFe, LiN(SO₂)₂, LiN(SO₂F)₂, LiCF₃SO₃, LiCIO₄, lithium difluoro oxalatoborate (LiDFOB), LiI, LiBr, LiCl, LiGH, LiNO₃, or any combination thereof. In certain of the foregoing embodiments, the active salt is (i) LiFSI, LiTFSI, or a combination thereof, or (ii) NaFSI, NaTFSI, or a combination thereof, the solvent is DMC, DME, DOL, EMC, or a combination thereof; and the active salt has a molar concentration in the electrolyte within a range of from 0.75 M to 1.5 M. In some embodiments, the concentration of the salt present in the electrolyte is about 0.01 M to about 1.5 M, from about 0.05 M to about 1.2 M, or from about 0.4 M to about 1.0 M.

In any or all of the above embodiments, the diluent may comprise a fluoroalkyl ether (also referred to as a hydrofluoroether (HFE). In some embodiments, the diluent comprises 1,1,2,2-tetrafluoroethyl-2,2,2,3-tetrafluoropropyl ether (TTE), bis(2,2,2-trifluoroethyl) ether (BTFE), 1,1,2,2,-tetrafluoroethyl-2,2,2-trifluoroethyl ether (TFTFE), methoxynonafluorobutane (MOFB), ethoxynonafluorobutane (EOFB), or any combination thereof. In any or all of the above embodiments, the solvent and the diluent may be miscible. In some embodiments, a LSE includes an active salt; a solvent comprising a carbonate solvent, an ether solvent, a phosphate solvent, dimethyl sulfoxide, water, or a combination thereof, wherein the active salt is soluble in the solvent; a diluent, wherein the diluent is immiscible with the solvent and wherein active salt has a solubility in the diluent at least 10 times less than a solubility of the active salt in the solvent; and a bridge solvent having a different composition than the solvent and a different composition than the diluent, wherein the bridge solvent is miscible with the solvent and with the diluent. Exemplary bridge solvents. include acetonitrile, dimethyl carbonate, diethyl carbonate, propylene carbonate, dimethyl sulfoxide, 1,3-dioxolane, dimethoxyethane, diglyme (bis(2-methoxyethyl) ether), triglyme (triethylene glycol dimethyl ether), tetraglyme (tetraethylene glycol dimethyl ether), or any combination thereof.

In some embodiments, the electrolytes may further include an electrode stabilizing additive to protect the electrodes from degradation. Thus, electrolytes of the present technology can include an electrode stabilizing additive that can be reduced or polymerized on the surface of a negative electrode to form a passivation film on the surface of the negative electrode. Likewise, inventive electrolytes can include an electrode stabilizing additive that can be oxidized or polymerized on the surface of the positive electrode to form a passivation film on the surface of the positive electrode. In some embodiments, electrolytes of the present technology further include mixtures of the two types of electrode stabilizing additives. The additives are typically present at a concentration of about 0.001 to 8 wt %.

In some embodiments, an electrode stabilizing additive is a substituted or unsubstituted linear, branched or cyclic hydrocarbon comprising at least one oxygen atom and at least one aryl, alkenyl or alkynyl group. The passivating film formed from such electrode stabilizing additives may also be formed from a substituted aryl compound or a substituted or unsubstituted heteroaryl compound where the additive comprises at least one oxygen atom. Alternatively, a combination of two additives may be used. In some such embodiments, one additive is selective for forming a passivating film on the cathode to prevent leaching of metal ions and the other additive can be selective for passivating the anode surface to prevent or lessen the reduction of metal ions at the anode.

Representative electrode stabilizing additives include 1,2-divinyl furoate, 1,3-butadiene carbonate, 1-vinylazetidin-2-one, 1-vinylaziridin-2-one, 1-vinylpiperidin-2-one, 1 vinylpyrrolidin-2-one, 2,4-divinyl-1,3-dioxane, 2 amino-3 vinylcyclohexanone, 2-amino-3-vinylcyclopropanone, 2 amino-4-vinylcyclobutanone, 2-amino-5-vinylcyclopentanone, 2-aryloxy-cyclopropanone, 2-vinyl-[1,2]oxazetidine, 2 vinylaminocyclohexanol, 2-vinylaminocyclopropanone, 2 vinyloxetane, 2-vinyloxy-cyclopropanone, 3-(N-vinylamino)cyclohexanone, 3,5-divinyl furoate, 3-vinylazetidin-2-one, 3 vinylaziridin 2 one, 3 vinylcyclobutanone, 3 vinylcyclopentanone, 3 vinyloxaziridine, 3 vinyloxetane, 3-vinylpyrrolidin-2-one, 4,4 divinyl-3 dioxolan 2-one, 4 vinyltetrahydropyran, 5-vinylpiperidin-3-one, allylglycidyl ether, butadiene monoxide, butyl vinyl ether, dihydropyran-3-one, divinyl butyl carbonate, divinyl carbonate, divinyl crotonate, divinyl ether, divinyl ethylene carbonate, divinyl ethylene silicate, divinyl ethylene sulfate, divinyl ethylene sulfite, divinyl methoxypyrazine, divinyl methylphosphate, divinyl propylene carbonate, ethyl phosphate, methoxy-o-terphenyl, methyl phosphate, oxetan-2-yl-vinylamine, oxiranylvinylamine, vinyl carbonate, vinyl crotonate, vinyl cyclopentanone, vinyl ethyl-2-furoate, vinyl ethylene carbonate, vinyl ethylene silicate, vinyl ethylene sulfate, vinyl ethylene sulfite, vinyl methacrylate, vinyl phosphate, vinyl-2-furoate, vinylcylopropanone, vinylethylene oxide, β-vinyl-γ-butyrolactone, or a mixture of any two or more thereof. In some embodiments the electrode stabilizing additive may be a cyclotriphosphazene that is substituted with F, alkyloxy, alkenyloxy, aryloxy, methoxy, allyloxy groups, or combinations thereof. For example, the additive may be a (divinyl)-(methoxy)(trifluoro)cyclotriphosphazene, (trivinyl)(difluoro)(methoxy)cyclotriphosphazene, (vinyl)(methoxy)(tetrafluoro)cyclotriphosphazene, (aryloxy)(tetrafluoro)(methoxy)-cyclotriphosphazene, (diaryloxy)(trifluoro)(methoxy)cyclotriphosphazene compounds, or a mixture of two or more such compounds. In some embodiments, the electrode stabilizing additive is vinyl ethylene carbonate, vinyl carbonate, or 1,2-diphenyl ether, or a mixture of any two or more such compounds.

Other representative electrode stabilizing additives may include compounds with phenyl, naphthyl, anthracenyl, pyrrolyl, oxazolyl, furanyl, indolyl, carbazolyl, imidazolyl, or thiophenyl groups. For example, electrode stabilizing additives may be aryloxpyrrole, aryloxy ethylene sulfate, aryloxy pyrazine, aryloxy-carbazole trivinylphosphate, aryloxy-ethyl-2-furoate, aryloxy-o-terphenyl, aryloxy-pyridazine, butyl-aryloxy-ether, divinyl diphenyl ether, (tetrahydro-furan-2-yl)-vinylamine, divinyl methoxybipyridine, methoxy-4-vinylbiphenyl, vinyl methoxy carbazole, vinyl methoxy piperidine, vinyl methoxypyrazine, vinyl methyl carbonate-allylanisole, vinyl pyridazine, 1-divinylimidazole, 3-vinyltetrahydrofuran, divinyl furan, divinyl methoxy furan, divinylpyrazine, vinyl methoxy imidazole, vinylmethoxy pyrrole, vinyl-tetrahydrofuran, 2,4-divinyl isooxazole, 3,4 divinyl-1-methyl pyrrole, aryloxyoxetane, aryloxy-phenyl carbonate, aryloxy-piperidine, aryloxy-tetrahydrofuran, 2-aryl-cyclopropanone, 2-diaryloxy-furoate, 4-allylanisole, aryloxy-carbazole, aryloxy-2-furoate, aryloxy-crotonate, aryloxy-cyclobutane, aryloxy-cyclopentanone, aryloxy-cyclopropanone, aryloxy-cycolophosphazene, aryloxy-ethylene silicate, aryloxy-ethylene sulfate, aryloxy-ethylene sulfite, aryloxy-imidazole, aryloxy-methacrylate, aryloxy-phosphate, aryloxy-pyrrole, aryloxyquinoline, diaryloxycyclotriphosphazene, diaryloxy ethylene carbonate, diaryloxy furan, diaryloxy methyl phosphate, diaryloxy-butyl carbonate, diaryloxy-crotonate, diaryloxy-diphenyl ether, diaryloxy-ethyl silicate, diaryloxy-ethylene silicate, diaryloxy-ethylene sulfate, diaryloxyethylene sulfite, diaryloxy-phenyl carbonate, diaryloxy-propylene carbonate, diphenyl carbonate, diphenyl diaryloxy silicate, diphenyl divinyl silicate, diphenyl ether, diphenyl silicate, divinyl methoxydiphenyl ether, divinyl phenyl carbonate, methoxycarbazole, or 2,4-dimethyl-6-hydroxy-pyrimidine, vinyl methoxyquinoline, pyridazine, vinyl pyridazine, quinoline, vinyl quinoline, pyridine, vinyl pyridine, indole, vinyl indole, triethanolamine, 1,3-dimethyl butadiene, butadiene, vinyl ethylene carbonate, vinyl carbonate, imidazole, vinyl imidazole, piperidine, vinyl piperidine, pyrimidine, vinyl pyrimidine, pyrazine, vinyl pyrazine, isoquinoline, vinyl isoquinoline, quinoxaline, vinyl quinoxaline, biphenyl, 1,2-diphenyl ether, 1,2-diphenylethane, o terphenyl, N-methyl pyrrole, naphthalene, or a mixture of any two or more such compounds.

In some embodiments, the electrolyte may include a weakly solvating electrolyte that may contain fluorinated solvents including, but not limited to, fluorinated carbonates such as trifluoroethyl methyl carbonate (FEMC), bis(2,2,2-trifluoroethyl) carbonate (HFDEC), fluoroethylene carbonate (FEC), difluoroethylene carbonate (DFEC); or fluorinated sulfones such as ((trifluoromethyl)sulfonyl)ethane (FMES), 1-((trifluoromethyl)sulfonyl)propane (FMPS), 1,1,2,2-tetrafluoro-3-(methylsulfonyl)propane (TFPMS); or fluorinated monoethers such as 1,1,2,2-tetrafluoroethyl-2,2,2,3-tetrafluoropropyl ether (TTE), bis(2,2,2-trifluoroethyl) ether (BTFE), 1,1,2,2,-tetrafluoroethyl-2,2,2-trifluoroethyl ether (TFTFE); or fluorinated glycol ethers such as 1,1,1-trifluoro-2-(2-(2-(2,2,2-trifluoroethoxy)ethoxy)ethoxy)ethane (FDG), 1,1,1-trifluoro-2-(2-(2-methoxyethoxy)ethoxy)ethane (mFDG); or fluorinated carbamates such as 3-(trifluoromethyl)oxazolidin-2-one (TFMO), methyl bis(trifluoromethyl)carbamate (MTFC), 4-fluoro-3-methyloxazolidin-2-one (FMO); or fluorinated amides such as N,N-bis(trifluoromethyl)acetamide (TFMA), 2,2,2-trifluoro-N,N-dimethylacetamide (TFDA); or fluorinated esters such as methyl 2,2,2-trifluoroacetate (MTFA), 4-fluorodihydrofuran-2(3H)-one (HFHO), 2,2,2-trifluoroethyl acetate (TFEA); or fluorinated sulfonamides such as 1,1,1-trifluoro-N,N-dimethylmethanesulfonamide (TFDS), N,N-bis(trifluoromethyl)methanesulfonamide (TFMMS).

In some embodiments, the electrolyte may also include a redox shuttle material. The shuttle, if present, will have an electrochemical potential above the positive electrode's maximum normal operating potential. Illustrative stabilizing agents include, but are not limited to, a spirocyclic hydrocarbon containing at least one oxygen atom and at least on alkenyl or alkynyl group, pyridazine, vinyl pyridazine, quinolone, pyridine, vinyl pyridine, 2,4-divinyl-tetrahydropyran, 3,9-diethylidene-2,4,8-trioxaspiro[5,5]undecane, 2-ethylidene-5-vinyl-[1,3]dioxane, 1,3,2-dioxathiolane 2,2-dioxide, 4-methyl-1,3,2-dioxathiolane 2,2-dioxide, 4-(trifluoromethyl)-1,3,2-dioxathiolane 2,2-dioxide, 4-fluoro-1,3,2-dioxathiolane 2,2-dioxide, 4,5-difluoro-1,3,2-dioxathiolane 2,2-dioxide, dimethyl sulfate, methyl (2,2,2-trifluoroethyl) sulfate, methyl (trifluoromethyl) sulfate, bis(trifluoromethyl) sulfate, 1,2-oxathiolane 2,2-dioxide, methyl ethanesulfonate, 5-fluoro-1,2-oxathiolane 2,2-dioxide, 5-(trifluoromethyl)-1,2-oxathiolane 2,2-dioxide, 4-fluoro-1,2-oxathiolane 2,2-dioxide, 4-(trifluoromethyl)-1,2-oxathiolane 2,2-dioxide, 3-fluoro-1,2-oxathiolane 2,2-dioxide, 3-(trifluoromethyl)-1,2-oxathiolane 2,2-dioxide, difluoro-1,2-oxathiolane 2,2-dioxide, 5H-1,2-oxathiole 2,2-dioxide, 2,5-dimethyl-1,4-dimethoxybenzene, 2,3,5,6-tetramethyl-1,4-dimethoxybenzene, 2,5-di-tert-butyl-1,4-dimethoxybenzene or a mixture of any two or more thereof, with the proviso that when used, the redox shuttle is not the same as the lithium salt, even though they perform the same function in the cell. That is, for example, if the lithium salt is LiClO₄, it may also perform the dual function of being a redox shuttle, however if a redox shuttle is included in that same cell, it will be a different material than LiClO₄.

In another aspect, a process of preparing the electrochemical cells is provided. The process(es) includes providing an electrochemical cell and activating the cell at a voltage of 4.5V or greater. In such methods, the electrochemical includes a cathode having a cathode active material and a pre-lithiation agent, an anode, and an electrolyte that includes an oxygen scavenger. As illustrated above, the methods is intended to sequester in situ oxygen species that are generated as a result of the high voltage pre-lithiation to prevent or at least minimize adverse effects that they may otherwise have on the cell.

In some embodiments, the activation of the cell is conducted at 4.2 to 6 V, or at 4.2 to 5 V, or at 4.5 to 6 V, or at 4.5 to 5 V, or may be conducted at about 4.2 V, about 4.3 V, about 4.4 V, about 4.5 V, about 4.6 V, about 4.7 V, about 4.8 V, about 4.9 V, or about 5.0 V.

In a further aspect, a method of coating Li₂O and/or Li₂O₂ on a cathode laminate leads to a significant activation of lithium oxide or lithium peroxide, thereby avoiding compatibility issues of making slurry and provide a high capacity depending on the amount of Li₂O and/or Li₂O₂. Conductive carbon and catalyst(s) may be added into a coating layer to facilitate the activation of electrochemical active materials. Suitable catalyst materials that may be added include nanostructured carbon functionalized, polymers, transition metal oxides, non-precious metals, precious metals, or metal alloys may also mix together. A solvent or co-solvent, such as toluene and hexane may need to help disperse the electrochemical active materials.

Where the battery is either a lithium ion or a sodium ion battery, the cathode may include a porous carbon material, and the electrochemical prelithiation or pre-sodiation active material. The amount of prelithiation or pre-sodiation material in the cathode may be from about 0.05 wt % to about 10 wt %. Where the battery is either a lithium ion or a sodium ion battery, the amount of oxygen scavenger in the electrolyte may be from about 0.01 wt % to about 10 wt %.

The electrochemical cells, cathodes, and batteries described herein may be used for a variety of applications including, but not limited to, portable electronics such as cell phones, laptop computers, and cameras, and in large power applications such in electric vehicles, hybrid electric vehicles, plug-in hybrid electric vehicles, and smart grids.

The present invention, thus generally described, will be understood more readily by reference to the following examples, which are provided by way of illustration and are not intended to be limiting of the present invention.

### EXAMPLES

General. One illustrative diagram of an electrochemical cell, i.e. “cell A,” is provided in FIGS. 1A and 1B. The cells are prepared by directly mixing alkaline source material with cathode slurry. LiCo_{0.6}Mn_{0.2}Ni_{0.2}O₂ (NMC622) was mixed with Li₂O₂, conductive carbon (“C45”) and binder (PVDF) in a mass ratio of (90-X):(X):5:5 to form a cathode slurry. The cathode slurry was cast on an aluminum current collector followed by drying at 70° C., and then vacuum drying at 100° C. for 24 hours. The obtained cathode laminate was then calendared and cut for assembly into cells.

Another illustrative diagram of an electrochemical cell, i.e. “cell B” is provided in FIG. 1B. To reduce the impedance built-up effect after the activation of Li₂O₂, we introduce a new cathode laminate design to mitigate the chemical reactions between Li₂O₂ and NMP/PVDF, as well as the conducting issue caused by gassing inside the cathode laminate during the cathode laminate fabrication process. For fabrication, a suspension of Li₂O₂ in dimethyl carbonate (DMC) or another inert, volatile solvent may be prepared, subject to vigorous mechanical stirring, and spread onto a cathode laminate. A solid-to-liquid mass ratio in the suspension is about 0.1. The coating layer was then dried at 85° C. and calendared prior to being assembled into the cell. The method of spread coating enables the combination of alkaline source material with catalyst and conductive carbon.

Example 1. A solution of 1.2 M LiPF6 in 3:7 ethylene carbonate:ethylmethyl carbonate (“EC/EMC”) was used as a baseline electrolyte. This baseline electrolyte combination is referred to herein and in the figures as the “GEN II” or “GEN 2” electrolyte. Lithium layered oxide material LiNi_{0.6}Mn_{0.2}Co_{0.2}O₂ (NMC622) was selected as a cathode material. A pre-lithiation agent was preloaded on the surface of the NMC622 cathode by spraying it with a solution/mixture of Li₂O₂ in a solvent such as DMC/DME, followed by vacuum drying.

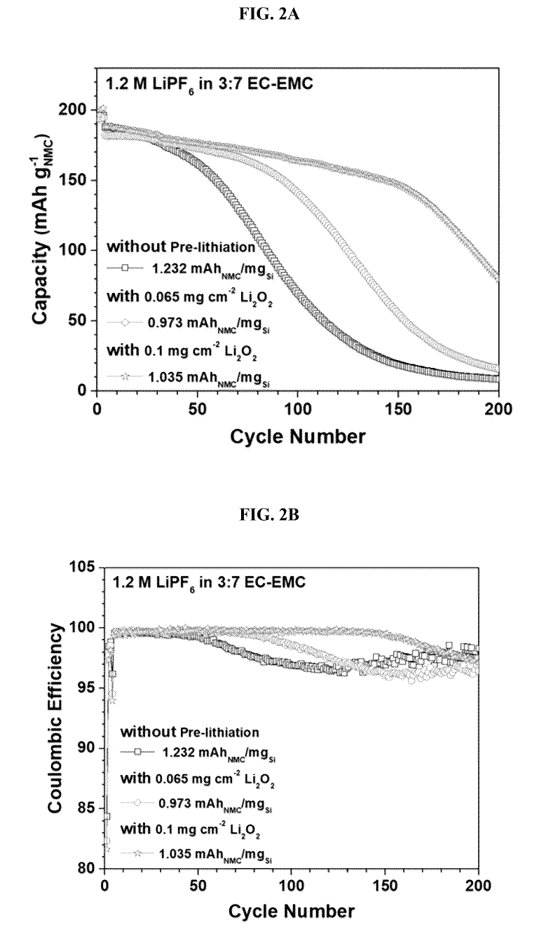

FIGS. 2A and 2B show cycling and Coulombic efficiency (“CE”) graphs for cells of NMC622-Li₂O₂∥Si in a GEN II electrolyte. FIG. 2A illustrates the graphical cycling data for full cells of NMC622∥Si (no prelithiation agent; control) and NMC622-Li₂O₂∥Si (prelithiated at about 1 and 2 wt %) having the same applied current density and electrolyte. Though higher charge-discharge capacity can be obtained during the slow charge-discharge (C/20) formation cycles for cells that were pre-lithiated with Li₂O₂, the capacity drops significantly after switching to a higher C-rate (C/3), though it stabilizes. In FIG. 2B, the initial decrease in CE indicates the activation of Li₂O₂ during the first five cycles. The increase in CE after the 5^{th} cycle shows the success of pre-lithiation by Li₂O₂. This result indicates that gaseous by-products do not necessarily harm long-term cycling, but they have a negative impact on rate cycling. The capacity retention and Coulombic efficiency of the cells were enhanced with increasing amount of Li₂O₂.

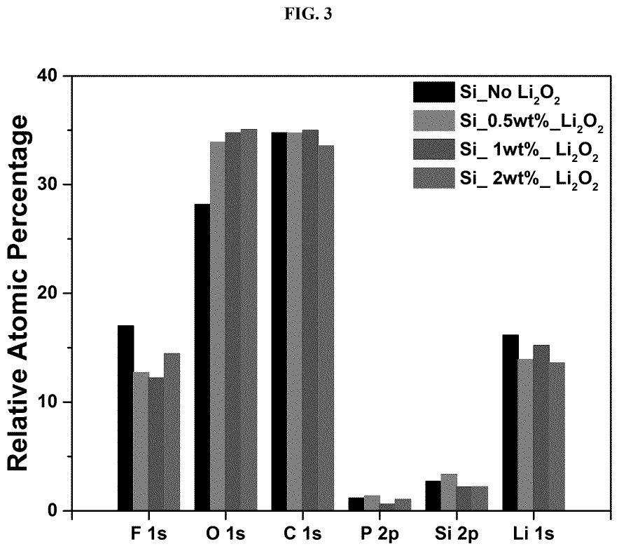

Example 2. This example shows the relative atomic ratio of harvested silicon anode from Si∥NMC622 full cells with different amounts of Li₂O₂, after 3 formation and activation cycles, measured by X-ray photoelectron spectroscopy (XPS). The relative ratio of oxygen element on harvested silicon anodes from the full cells with Li₂O₂ addition and activation was significantly higher than the full cell without any Li₂O₂ addition on cathode, as depicted in FIG. 3. The result suggests parasitic reactions occurred between the reactive oxygen-containing by-products (mainly dioxygen gas), which are generated during the activation of Li₂O₂ and the lithiated silicon anode.

Example 3. The addition of oxygen scavengers, such as tetrahydrothiophene 1-oxide (THTO), will scavenge the by-products and THTO itself will turn into tetramethylene sulfone (TMS), which is just another widely used solvent for Li-ion batteries. Upon oxidation, THTO will be oxidized to TMS as depicted in Scheme 2.

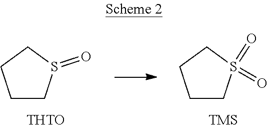

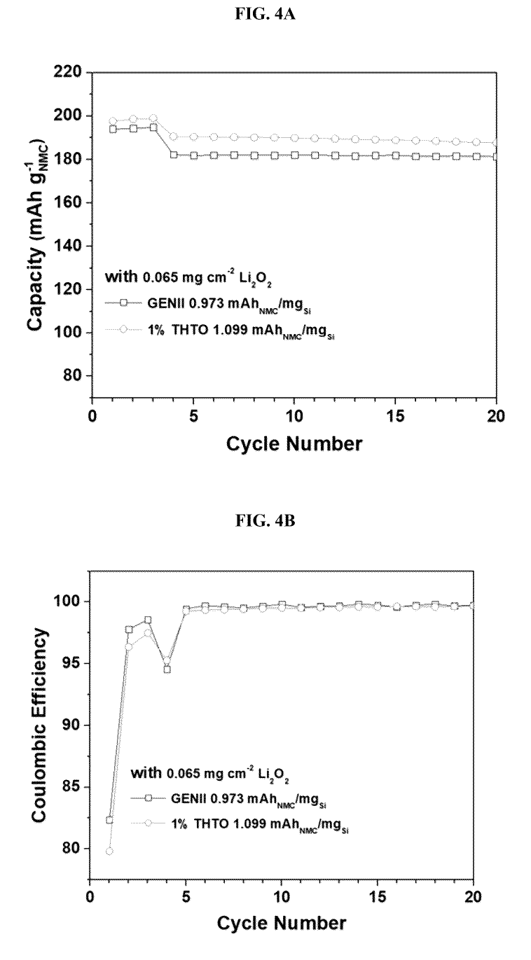

FIGS. 4A and 4B show representative cycling and Coulombic efficiency (CE) of NMC622-Li₂O₂∥Si with a GEN II electrolyte, and both with and without 1% THTO. FIG. 4A is graph of capacity for a NMC622-Li₂O₂∥Si full cell tested with the same current density, and with or without an electrolyte additive. Higher charge-discharge capacity can be obtained after adding THTO even after switching to a higher C-rate (C/3) cycling. As shown in FIG. 4B, the initial decrease of CE indicates the activation of Li₂O₂ during the first three cycles. After the activation of Li₂O₂ on NMC622, there was a significant increase in the specific capacity of the Si∥NMC cell with the addition of THTO additive, while the Coulombic efficiency was not affected by THTO addition.

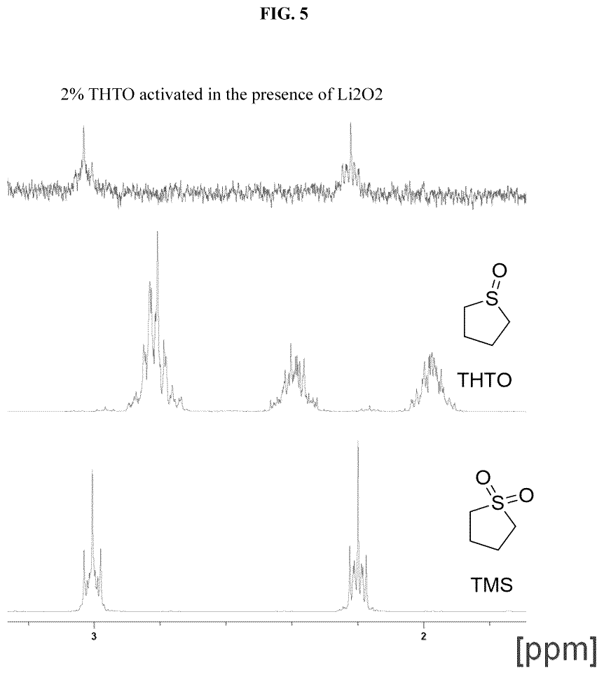

Example 4. This example shows the proton NMR spectra of pure THTO, TMS and the harvested electrolyte (conventional electrolyte with 1 wt. % THTO) after 3 formation cycles in FIG. 5. The result shows clearly the oxidation of THTO to TMS after the activation of Li₂O₂ from the Si∥NMC cell.

Example 5. The addition of oxygen scavenger tris(2,2,2-trifluoroethyl) phosphite (TTFPi), will scavenge the by-products and TTFPi itself will turn into tris(2,2,2-trifluoroethyl)phosphate (TTFPa). Upon oxidation, TTFPi will be oxidized to TTFPa as shown in Scheme 3.

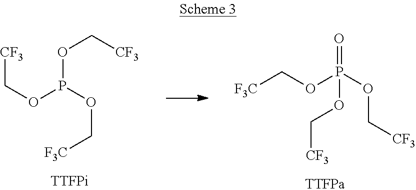

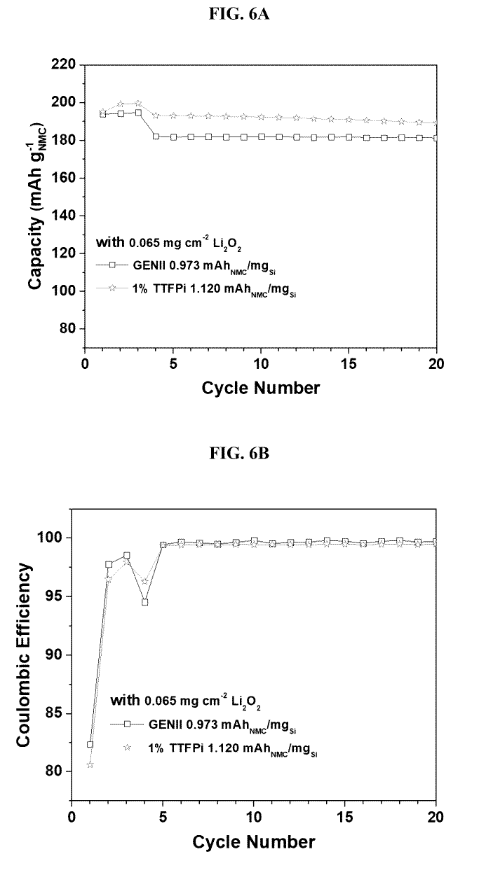

FIGS. 6A and 6B show the representative cycling and Coulombic efficiency (CE) of NMC—Li₂O₂∥Si with a GEN II electrolyte, and with and without TTFPi. FIG. 6A is the capacity cycling for a full cell with NMC-Li₂O₂∥Si full cells tested with the same current density, but with and without an electrolyte additive. Higher charge-discharge capacity and better CE can be obtained after adding TTFPi at slow and high C-rate cycling. The initial decrease of CE in FIG. 6B indicates the activation of Li₂O₂ during the first three cycles. The increase of capacity and CE indicates the success of applying TTFPi as an O scavenger.

Example 6. The cell using GEN II electrolyte with 2% TTFPi was dissembled after the activation process, and the electrolyte was washed with CDCl₃ solvent. FIG. 6 shows the ¹⁹F-NMR spectra of pure TTFPi, TTFPa, and the harvested electrolyte. As shown, a large portion of TTFPi was oxidized to TTFPa during the activation of Li₂O₂, or, in other words, the TTFPi scavenged the highly reactive intermediates produced during the activation of the Li₂O₂.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, agents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. An electrochemical cell comprising:
a cathode comprising a pre-lithiation or pre-sodiation agent;
an anode; and
an electrolyte comprising an oxygen scavenger;
wherein the electrochemical cell is configured to operate at a voltage greater than 4.2 V.

2. The electrochemical cell of claim 1, wherein the cathode is a laminated cathode comprising layers of a current collector, a cathode active material, and a pre-lithiation agent.

3. The electrochemical cell of claim 1, wherein the cathode active material comprises a binder and the pre-lithiation agent or pre-sodiation agent is distributed throughout the cathode active material and the binder.

4. The electrochemical cell of claim 1, wherein the pre-lithiation or pre-sodiation agent is present ether as a coating on the surface of the cathode active material, and the ratio of pre-lithiation or pre-sodiation to cathode active material is from greater than 0 wt % to less than 15 wt %.

5. The electrochemical cell of claim 1, wherein the pre-lithiation or pre-sodiation agent comprises Li₂O, Li₂O₂, LiO₂ Na₂O, Na₂O₂, NaO₂ a high lithium/high manganese content lithium metal oxide material, or a mixture thereof.

6. The electrochemical cell of claim 1, wherein the cathode active material comprises LiCoO₂, LiFePO₄, LiMn₂O₄, LiMeO₂, Li_{1+x″}Ni_{α}Mn_{β}Co_{γ}Mδ·O₂, δLi₂M⁷O₃·(1-δ)LiM⁸O₂, wherein Me may be Ni, Mn, or Co; M may be Mg, Zn, Al, Ga, B, Zr, or Ti; M⁷ is one or more trivalent ions with at least one ion being Mn³⁺ or Ni³⁺, and where M⁸ is one or more tetravalent ions, with 1>δ>0; 0≤x″≤0.4; 0≤α≤1; 0≤β≤1; 0≤δ′≤1; and 0≤γ≤1; with the proviso that at least one of α, β and γ is greater than 0; NaFePO₄, NaCoO₂, NaNiO₂, NaNi₁₋ₓCo_{y}M⁴_{z}O₂, NaMn_{0.5}Ni_{0.5}O₂, NaMn_{1/3}Co_{1/3}Ni_{1/3}O₂, NaMn₂O₄, NaFeO₂, NaM⁴_{0.5}Mn_{1.5}O₄, Na_{1+x″}Ni_{α}Mn_{β}Co_{γ}M⁵_{δ}O_{2-z″}F_{z″}, Na₂MnO₃—NaₐM_{b}M′_{c}M″_{d}Oₑ, Naₙ·B¹₂(M²O₄)₃ (Nasicon), Na₂MSiO₄, Na₁₋ᵥM⁵O₂, NaVPO₄F or a mixture of any two or more thereof, wherein M² is P, S, Si, W, or Mo; M⁴ is Al, Mg, Ti, B, Ga, Si, Mn, or Co; M⁵ is Mg, Zn, Al, Ga, B, Zr, or Ti; M⁵ is a trivalent metal ion that includes Mn³⁺ and/or Fe³⁺; M, M′, and M″ are transition metals; B¹ is Ti, V, Cr, Fe, or Zr; 0≤v≤0.56; 0≤x≤0.3; 0≤y≤0.5; 0≤z≤0.5; 0≤m≤0.5; 0≤n≤0.5; 0≤x″≤0.4; 0≤a≤2; 0≤b≤1; 0≤c≤1; 0≤d≤1; 0≤δ≤1; 0≤β≤1; 0≤γ≤1; 0≤δ≤1; 0≤δ′≤0.4; 0≤z″≤0.4; 0≤n′≤3; 0<a+b+c+d, and 0<e.

7. The electrochemical cell of claim 1, wherein the cathode active material comprises LiCoO₂, LiFePO₄, LiMn₂O₄, LiNi_{1/3}Mn_{1/3}Co_{1/3}O₂, LiNi_{0.8}Co_{0.15}Al_{0.05}O₂, LiNi_{0.6}Mn_{0.2}Co_{0.2}O₂, LiNi_{0.8}Co_{0.1}Mn_{0.1}O₂, LiNi_{0.9}Co_{0.05}Mn_{0.05}O₂, LiNi_{0.5}Mn_{1.5}O₄, Li_{1.2}Ni_{0.15}Co_{0.10}Mn_{0.55}O₂ (0.49Li₂MnO₃·0.51LiNi_{0.37}Co_{0.24}Mn_{0.39}O₂), or LiFe_{0.4}Mn_{0.6}PO₄, or LiFe_{0.3}Mn_{0.7}PO₄.

8. The electrochemical cell of claim 1, wherein the cathode active material comprises a spinel manganese oxide of formula of Li₁₊ₓMn_{2-z}M⁴_{y}O₄₋ₘX¹ₙ, wherein M⁴ is Al, Mg, Ti, B, Ga, Si, Ni, or Co; X¹ is S or F; 0≤x≤0.3; 0≤y≤0.5; 0≤z≤0.5; 0≤m≤0.5; and 0≤n≤0.5.

9. The electrochemical cell of claim 1, wherein the cathode active material comprises an olivine structured material of formula of LiFe_{1-z}M⁶_{y}PO₄₋ₘX¹ₙ or a mixture of any two or more thereof; wherein M⁶ is Al, Mg, Ti, B, Ga, Si, Ni, Mn or Co; X¹ is S or F; 0≤x≤0.3; 0≤y≤0.5; 0≤z≤0.5; 0≤m≤0.5; and 0≤n≤0.5

10. The electrochemical cell of claim 1, wherein the cathode active material comprises NaM₁₋ₓM′ₓPO₄, NaₓM_{y}M′_{z}O₂, Na₂FePO₄F, Na₂MnPO₄F, NaFeSO₄F, NaMnSO₄F, NaV_{1-α}Cr_{α}PO₄F, Na₂S, Na₂Se, Na₃M⁶₂(PO₄)₃; Na₂M⁶P₂O₇; Na₄M⁶₃(PO₄)₂(P₂O₇); NaₓM⁶_{y}(PO₄)_{z}F; NaₓM⁶_{y}(SO₄)_{z}; Na₂M⁶SiO₄, or a mixture of any two or more thereof, wherein 0<x; 0<y+z; M is Mn, Ni, Fe, Co, or Cu; M′ is Cr or Mg; M⁶ is a tetravalent ion; and 0≤α≤1

11. The electrochemical cell of claim 1, wherein the oxygen scavenger comprises dimethyl sulfoxide, bis(trifluoroethyl) sulfoxide, tetrahydrothiophene 1-oxide, ethylene sulfite, dimethyl sulfite, methoxydimethylphosphane, methoxybis(2,2,2-trifluoroethyl)phosphane, 1-methoxyphospholane, diethyl methylphosphonite, dimethyl phenylphosphonite, trimethyl phosphite, 2-methoxy-1,3,2-dioxaphospholane, tris(2,2,2-trifluoroethyl) phosphite, or a mixture of any two or more thereof.

12. The electrochemical cell of claim 1, wherein the oxygen scavenger comprises thiophene 1-oxide, tetrahydrothiophene-1-oxide, or a mixture of any two or more thereof. or a mixture of any two or more thereof.

13. The electrochemical cell of claim 1, wherein the oxygen scavenger is present in the electrolyte from about 0.01 wt % to about 8 wt %.

14. The electrochemical cell of claim 1, wherein the electrolyte further comprises an oxidized oxygen scavenger.

15. The electrochemical cell of claim 14, wherein the oxidized oxygen scavenger comprises, tetrahydrothiophene 1-oxide, dimethyl sulfoxide, fluorinated alkyl sulfoxide, ethylene sulfite, floroethylene sulfite, alkyl phosphinite, fluorinated alkyl phosphinite, alkyl phosphonite, fluorinated alkyl phosphonite, trimethylphosphite, tris(2,2,2-trifluoroethyl) phosphite, trialkyl phosphite, fluorinated trialkyl phosphite, lithium chlorate, or a mixture of any two or more thereof.

16. The electrochemical cell of claim 1, wherein the electrolyte further comprises a polar aprotic solvent and a salt.

17. The electrochemical cell of claim 1, wherein the anode comprises conductive carbon material, Li metal, Cu, Sb, Si, Si—C, SiO, Sn, tin oxide, Li₄Ti₅O₁₂, a composite tin alloy, a transition metal oxide, a lithium metal nitride, phosphorus, a phosphorus carbon composite, or a mixture of any two or more thereof.

18. The electrochemical cell of claim 1, wherein the anode comprises silicon, Si-oxide, Si-Graphene composite

19. A process of preparing an electrochemical cell, the process comprising:
providing a cathode comprising a cathode active material and a pre-lithiation agent, a pre-sodiation agent, or both a pre-lithiation and pre-sodiation agent;
providing an anode; and
providing an electrolyte comprising an oxygen scavenger;
assembling the electrochemical cell with the cathode and anode separated by a porous separator;
charging the electrochemical cell at a potential of 4.2 V or greater to pre-lithiate and/or presodiate the cathode active material.

20. The process of claim 19, wherein the pre-lithiation and/or pre-sodiation agent comprises Li₂O, Li₂O₂, LiO₂, Na₂O, Na₂O₂, NaO₂ a high lithium/high manganese content lithium metal oxide material, or a mixture thereof; and the oxygen scavenger comprises dimethyl sulfoxide, bis(trifluoroethyl) sulfoxide, tetrahydrothiophene 1-oxide, ethylene sulfite, dimethyl sulfite, methoxydimethylphosphane, methoxybis(2,2,2-trifluoroethyl)phosphane, 1-methoxyphospholane, diethyl methylphosphonite, dimethyl phenylphosphonite, trimethyl phosphite, 2-methoxy-1,3,2-dioxaphospholane, tris(2,2,2-trifluoroethyl) phosphite, a high lithium/high manganese content lithium metal oxide material, a high sodium/high manganese content sodium metal oxide material, or a mixture of any two or more thereof.
